(19) United States
(12) Patent Application Publication
(10) Pub. No.: US 2006/0288220 A1
(43) Pub. Date: Dec. 21, 2006

(54) In-line website securing system with HTML processor and link verification

(75) Inventors: Bill Pennington, San Jose, CA (US); Jeremiah Grossman, San Jose, CA (US); Robert Stone, Mountain View, CA (US); Siamak Pazirandeh, San Diego, CA (US); Lex Arquette, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: WhiteHat Security, Inc., Santa Clara, CA (US)

(21) Appl. No.: 11/415,794

(22) Filed: May 1, 2006

Related U.S. Application Data
(60) Provisional application No. 60/677,207, filed on May 2, 2005.

(51) Int. Cl. H04L 9/00

(52) U.S. Cl. 713/176

(57) ABSTRACT

A web application firewall (WAFs) used to secure websites from many known and unknown vulnerabilities is described. In one embodiment, the WAF is installed between a server that is serving web content and a network over which clients access the website hosted on the server. The WAF is configured to provide security from external attacks by preventing the website from receiving data that it did not send, and that the data received was not altered by a client. The WAF encodes outbound HTTP response data such that when a client or interloper follows one of the links or other constructs in the response data, the WAF can determine the validity of the next client request. In one embodiment, each universal resource locator link is encrypted and checked for validity when it is returned to the server via the WAF.

### CROSS-REFERENCES TO RELATED APPLICATIONS

This application claims priority to U.S. Provisional Patent Application No. 60/677,207, entitled “In-Line Website Securing System with HTML Processor and Link Verification” filed May 2, 2005, which is hereby incorporated in its entirety.

### BACKGROUND

The present invention relates to website security systems in general and more particularly to securing websites from attacks that use information from pages served by the website.

A website is a collection of pages, documents, operations, etc. served or handled at one or more servers such that together the impression is that the collection is available at one location on a network such as the Internet. Generally, a website collection is maintained by one entity that has control over the content that is included in that collection as well as the interactions of users with that collection. For example, the website operator might collect information from users and store that information securely for use in furthering the website operator's and the user's mutual interest (such as soliciting a credit card number in order to consummate a sale of a product offered to the user via the website). As such, the website operator would need to secure the website (i.e., the content, servers, data, interfaces, etc. that comprise the website) against attacks from others that would thwart the operator's purpose, such as to modify the content, open up functions of the website that are not intended to be open beyond the purview of the operator, or to have unauthorized access to data collected via the website.

One approach to identifying security vulnerabilities in a website is to examine the source code for the web applications that form part of the collection to identify risk-prone operations. However, this might not provide a complete picture of vulnerabilities, as the execution structure of the code might not be apparent from reviewing the code and the interplay of the examined code and other parts of a web application might introduce other vulnerabilities. Additionally, while examined code might be secure, it is possible for an unauthorized client device to modify client-side code or traffic to or from the website to do something unplanned and untested for.

One approach to security is to use a rule-based web application firewall (WAF) that validates incoming HTTP request data using string matching or other techniques. Such devices might also attempt to identify incoming attacks using a signature approach. Signature-based approaches often look for specific strings of characters that are indicative of an attempt to hack a website or web application. For example, the following is an example of a string that a signature-based approach may be looking for:

../../../../etc/password
SELECT+*+FROM+
<SCRIPT>
/bin/ls

Such conventional rule-based and signature-based systems have proven difficult to configure and are time consuming to manage. Furthermore, Intrusion Detection Systems (IDSes) using this approach have components that typically generate large numbers of false-positives (i.e., alerts to a security event that is not really a security event requiring action or notice) making the solution infeasible in real-world applications. The data input requirements of a website are in constant flux and the WAF's rules need corresponding frequent updates, which is a less than optimal solution.

### SUMMARY

Embodiments of the present invention provide a WAF installed between a server that is serving web content and a network over which clients access the website. The WAF process incoming requests and data with the general premise that clients cannot all be trusted and the network connections between trusted clients and the server also cannot be trusted. In one embodiment, the WAF encodes outbound HTTP response data such that when a client or interloper follows one of the links or other constructs in the response data, the WAF can determine the validity of the next client request by enforcing the rule that the website does not receive any link/data/etc. that it did not send and that the values were not altered by the client (or an interloper).

In one embodiment, the WAF digitally signs outbound HTTP response data such that when a client or interloper follows one of the links or other constructs in the response data, the WAF can determine the validity of the next client request by verifying the digital signature.

In another embodiment, the present invention provides a method of securing a server. The method includes receiving a request for data associated with a website stored on a server, digitally signing the data transmitted from the server, receiving the digitally signed data as part of a second request, and validating the digitally signature of the data transmitted matches the digital signature of the data received.

In another embodiment, the present invention provides an apparatus for securing a server. The apparatus includes an encryption engine configured to digitally sign data transmitted from the server in response to a first data request, and a validation engine configured to determine that the digital signature of the data transmitted matches a digital signature of data received as part of a second data request associated with the data transmitted.

In another embodiment, the present invention provides a system for securing servers. The system includes a server and a firewall coupled between the server and a network. The firewall is configured to digitally sign data transmitted from the server to the network in response to a first data request from the network, and verify that data received from the network in response to a second data request associated with the data transmitted has the same digital signature.

### BRIEF DESCRIPTION OF THE DRAWINGS

FIG. 1 is a high-level block diagram of a network employing a web application firewall (WAF) in accordance with embodiments of the invention;

FIG. 2 is a high-level block diagram of a web application firewall in accordance with embodiments of the invention;

FIG. 3 is flow diagram illustrating a method of securing websites from vulnerabilities in accordance with embodiments of the invention;

FIG. 4 is flow diagram illustrating a method of digitally signing data transmitted from a web server to one of more clients requesting the data in accordance with embodiments of the invention; and

FIG. 5 is flow diagram illustrating a method of validating data received from one or more clients in accordance with embodiments of the invention.

These and other embodiments of the invention are described in further detail below.

### DETAILED DESCRIPTION OF EXEMPLARY EMBODIMENTS

Embodiments of the present invention provide a system and method to analyze data such as webpage content that passes between a client and a web server to determine if the webpage content that was sent from a web server was altered. In one embodiment, a web application firewall (WAF) is installed between a server that is serving web content and a network over which clients access the website. The WAF process incoming requests and data with the general premise that clients cannot all be trusted and the network connections between trusted clients and the server also cannot be trusted. In one embodiment, the WAF digitally signs (e.g., encodes) outbound data and then analyzes subsequent client requests to determine the validity of those requests by enforcing the rule that the website does not receive any link/data/etc. that it did not send and that the values were not altered by the client (or an interloper).

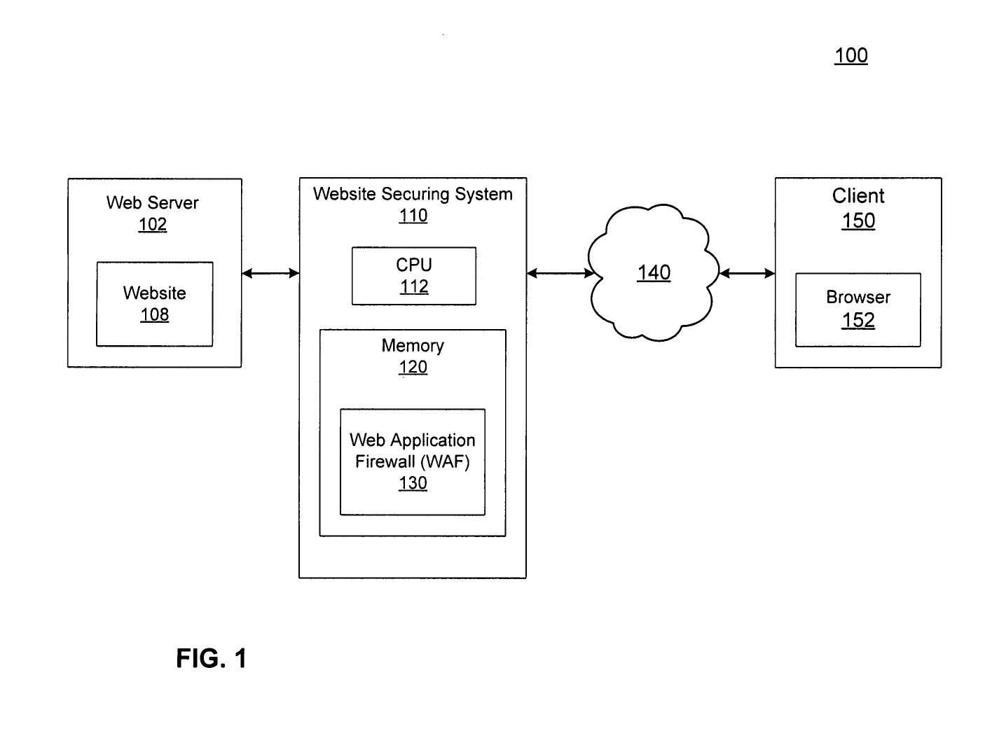

FIG. 1 is a high-level block diagram of a network system 100 employing a website securing system 110. In one embodiment, as illustrated in FIG. 1, network system 100 includes web server 102 serving respective websites 108 through website securing system 110 to one or more clients 150 coupled to website securing system 110 via a communication network 140. Communication network 140 may be any network, such as the Internet, a local area network (LAN), a wide area network (WAN), a wireless network, a wire-line network, etc. While illustrated as a stand alone system, all or part of website securing system 110 may be included in web server 102.

In one embodiment, web server 102 is a computer that holds the files for one or more websites 108. In some cases, website 108 may be split over a number of servers in different geographical locations. Website 108 may be any software application. In one embodiment, website 108 is a collection of files. For example, website 108 may include a beginning file called a home page. This home page may be associated with an identifier, such as a universal resource locator (URL), such as http://www.<testdomain>.com, http://www.<testdomain>.com/index.html, or the like. The URL corresponds to a file that is being stored. From a home page, other pages may be accessed using links on the home page. The other pages may be associated with other URLs, such as www.<otherhost>.com/login.html. A person of skill in the art will appreciate additional details regarding web sites that are not described. Although the terms webpages and websites are used herein, it will be understood that these terms may include applications that are not web based. While examples of URLs are presented in this disclosure, they are not intended to reference specific web domains, pages, etc., unless otherwise indicated. Hosts/domains enclosed with “< >” are placeholders for host/domain names, not necessarily actual hosts.

When a client, such as client 150, requests website 108, web server 102 may use a file stored on the web server 102 in order to serve webpages and other data related to website 108 to the client 150. The website 108 may then be displayed on an interface, such as web browser 152. Actions may then be performed with the website 108. For example, items may be selected (“clicked”) to request other webpages, text may be entered, forms may be filled, documents transferred, Flash (file extension .fla or .swf) or java applet applications may be invoked, etc. Requests indicating these actions may be sent to one or more web servers 102 for further processing. For example, login information, such as a username and password, may be entered on a webpage in order to login to web site 108. In this case, a user may access a restricted webpage that is only accessible if the login information is entered. For example, a restricted webpage may show a user's personal email account information.

A protocol may be used in communications between browser 152 and web server 102. In one embodiment, the HyperText Transfer Protocol (HTTP) is used. Using the example above, login information, such as a username and password, account number or related information, is entered in a webpage sent in a request. The login information may be any information that allows access to restricted parts of website 108. The login information sent in the request may allow a user to login into website 108. In one embodiment, in response to receiving the login information, credential information may be sent in a response from web server 102. Credential information may be any information that may be needed to access the restricted parts of website 108. The credential information may be stored and sent with future requests by a client that sent the request. For example, HTTP cookies, URL parameter schemes, or other HTTP headers may be used to retain the credential information for future requests.

Website securing system 110 includes a central processing unit (CPU) 112 and memory 120 which may include all or a portion of a WAF 130. Memory 120 is preferably random access memory sufficiently large to hold the necessary programming and data structures required for the operation of the website securing system 110. While memory 120 is shown as a single entity, it should be understood that memory 120 may in fact comprise a plurality of modules, and that memory 120 may exist at multiple levels, from high speed registers and caches to lower speed but larger DRAM chips.

WAF 130 may be configured in one embodiment as an in-line device placed between web server 102 handling the website 108 and network 140 over which clients 150 interact with the web server 102. Alternatively, WAF 130 may be located on network 140 where a load balancer (not shown) or network firewall (not shown) might be placed. As the WAF 130 is in-line, WAF 130 is able to detect and protect websites 108 from attack without consideration for the type of platform technologies are being used. In addition, WAF 130 is positioned to protect multiple websites 108 or web servers 102 as a single point of management. Thus, WAF 130 may operate independent of the website 108, without modifications to the web application, and operate independent of the browsers 152 and web servers 102. In one embodiment, WAF 130 may be configured as a reverse proxy which is inserted between browser(s) 152 and web server(s) 102 by modifying an associated domain name server (DNS) lookup table.

In one embodiment, WAF 130 enables the detection and assessment of a plurality of known and unknown security vulnerabilities associated with requests from client 150. As website 108 may have data, files, and the like with references to more than one web server, security vulnerabilities may be associated with a plurality of web servers (e.g., web server 102). Security vulnerabilities include but are not limited to application specific vulnerabilities, which are security holes within the website's own specific application, and security vulnerabilities embedded in client-side application files, such as Flash files or Java applets, that may be associated with website 108, or other websites, and servers used to service the client-side application files. These security vulnerabilities arise from an application-level interfaces between the client and servers and include, but are not limited to, path vulnerabilities, parameter vulnerabilities, and the like.

For example, the WAF 130 can effectively defend against the majority of WASC's 24 Classes of Attack (WASC provides a widely agreed-upon industry standard for comprehensively describing types of web application attacks), the OWASP Top-10 list of most common web application vulnerabilities), web-based worms, and zero-day buffer overflow exploits. As an added convenience, WAF 130 may be employed without intensive configuration changes, changes to the web server configuration, and web application code change, while minimizing performance degradation of network system 100. In an embodiment, WAF 130 may be employed to secure web applications for which the source code is not available or code-level modifications are not allowed. This is advantageous where an end-user organization needs a higher level of security than simply relying on secure operation of a web application developed outside the organization.

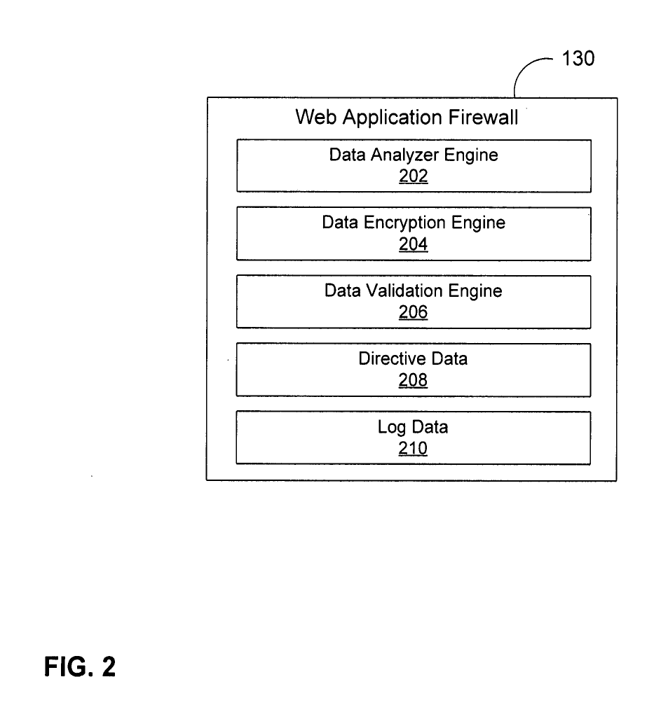

FIG. 2 is a high-level block diagram of WAF 130. In one embodiment, WAF 130 includes a data analyzer engine 202, data encryption engine 204, data validation engine 206, directive data 208, and log data 210. Data analyzer engine 202 may be configured to pass or not pass data requests to web server 102 in response to a control command referred to herein as a “directive”. For example, in response to an “activated” directive used to set the WAF 130 to an “on” condition, data analyzer engine 202 prevents data requests from being delivered to web server 102 without further data analysis by WAF 130. In response to a “deactivated” directive used to set WAF 130 to an “off” condition, data analyzer engine 202 allows data requests from being delivered to web server 102.

Data analyzer engine 202 may perform several different tests and functions for both inbound data and output data such as checking data format, data bypass, cookie checks, data exclusion, data cache, and the like, embodiments of which are described further below. For example, data analyzer engine 202 may analyze the format of an incoming URL for proper formatting. In one embodiment, data analyzer engine 202 may analyze the format of the incoming URL for proper request for comment (RFC) compliance. Data analyzer engine 202 may apply a “URL Exclude” directive to determine which, if any, URLs should bypass any further security tests. Data analyzer engine 202 may apply a URL Cache lookup process to determine if incoming encrypted URLs exist in memory.

Data analyzer engine 202 may be configured to perform parsing functions. For example, data analyzer engine 202 may be configured as a fast and robust (D|X)HTML, style-sheet, JavaScript, or other form of content document parser. Data analyzer engine 202 is able to handle non-compliant syntax extracting all embedded URLs in website 108.

In one embodiment, data encryption engine 204 is employed to digitally sign data being delivered from web server 102 to client 150. For example, data encryption engine 204 may be employed to encrypt URLs and cookies in response to a “URL encryption directive” and a “cookie encryption directive”. Two exemplary methods of encryption are described herein as “synchronous encryption” and “digest encryption”. For URLs, an example URL encryption directive used to perform URL protection may be:

| | |
|---|---|
| Syntax: | URLEncryption MD5\|SHA1\|SHA256\|AES\|TWOFISH |
| | secret\|key-filepath |
| Default: | URLEncryption AES website_secure/aes_key |

The URL encryption directive configures data encryption engine 204 to the type of encryption scheme and algorithm used to protect URLs. The URL encryption directive also specifies the secret or the key to complete the process.

Data encryption engine 204 may be configured to perform a synchronous encryption process. For example, using the encryption algorithm and key-filepath specified in the URL encryption directive, data encryption engine 204 encrypts and encodes a URL and replaces it for the original value in the document. Example:

| | |
|---|---|
| Original: | <a href=“/foo.html”>foo</a> |
| Method: | <a href=“ENC(<url>)”>foo</a> |
| New: | <a href=“<cipher-text>”>foo</a> |

Data encryption engine 204 may be configured to perform a digest encryption process. For example, using the encryption algorithm above and secret specified in the URL encryption directive, data encryption engine 204 digests the URL plus the secret then places the resulting digest onto the end of the original URL delimited by an ampersand. For example:

| | |
|---|---|
| Original: | <a href=“/foo.html”>foo</a> |
| Method: | <a href=“/foo.html&ENC(<url> + <secret>)”>foo</a> |
| New: | <a href=“/foo.html&<validation-digest>”>foo</a> |
| | Validation-digest = DigestAlgorithm(url-value + secret); |

While both synchronous URL encryption or digest URL encryption may be used, as no information can be derived from the path, synchronous URL encryption may degrade search engine rankings. Such search engine ranking degradation may be addressed by employing digest URL encryption rather than synchronous URL encryption, adding URL exclude rules for URLs, or path sections where search rank is important, and the like. In addition, without proper configuration, using URL encryption may break currently indexed or posted links. This can be addressed using digest URL encryption rather than synchronous encryptions. URLs embedded within rich client-side media (Flash, ActiveX, Applets) generally cannot be replaced with encrypted URLs. To address this, WAF 130 may re-code the rich client-side media with encrypted URLs, and add URL exclude rules on rich client-side media URLs.

In one embodiment, to protect cookies from unauthorized data tampering and theft, the data encryption engine 204 may be configured to encrypt cookies. An example cookie encryption directive used to perform cookie protection is as follows:

| | |
|---|---|
| Syntax: | CookiesEncryption MD5\|SHA1\|SHA256\|AES\|TWOFISH |
| | secret\|key-filepath |
| Default: | CookiesEncryption AES website_secure/aes_key |

The cookies encryption directive configures data encryption engine 204 to the type of encryption scheme and algorithm used to protect cookies.

Data encryption engine 204 may be configured to perform a synchronous encryption process for cookies. For example, using the encryption algorithm above and key-filepath specified in the cookies encryption directive, data encryption engine 204 may be configured to encrypt and encode cookie values and replace them with the original cookie values before passing the encrypted cookies to the client 150. All cookies that are not excluded may be rolled into one encrypted cookie package. For Example:

| | |
|---|---|
| Set-Cookie: | Encrypted-Cookie=ENC(name1=cookie-value; |
| | NAME2=cookie-value) |

Data encryption engine 204 may be configured to perform a digest encryption process. For example, using the encryption algorithm and secret specified in the cookies encryption directive, data encryption engine 204 may digest the cookie value plus the secret then place the resulting digest onto the end of the cookie delimited by an ampersand. For example:

| | |
|---|---|
| Cookie: | NAME1=<cookie-value>&Validation-Digest=ENC(cookie- |
| | value); |
| | Validation-digest = DigestAlgorithm(cookie-value + secret); |

In one embodiment, data validation engine 206 is employed to validate data (e.g., website data requests) from client 150. For example, data validation engine 206 may be employed to validate URLs and cookies signed in compliance with the URL encryption directive and the cookie encryption directive. For example, using the encryption algorithm and key-filepath specified in the URL and cookie encryption directive, data validation engine 206 may decrypt and decode the URL and cookie data. Two exemplary methods of cookie decryption are described herein as “synchronous decryption” and “digest decryption”. For cookies, an example cookie decryption directive used to perform URL validation may be:

| | |
|---|---|
| Cookie: | NAME1=<cookie_value>; NAME2=<cookie_value>... |

Data validation engine 206 may be configured to make sure each cookie value has a valid protected digest name/value pair (validation-digest) on the end, and check that the value of the character-set and data format of the validation-digest are proper. The validation-digest should only exhibit characters that are possible using the specified digest algorithm.

In one embodiment, data validation engine 206 employs the encryption, algorithm and secret specified in the cookies encryption directive for data validation. Data validation engine 206 compares the cookie value plus the secret digest to the validation-digest. For example:

| | |
|---|---|
| Cookie: | NAME1=<cookie-value>&SECURE=<validation-digest>; |
| | Validation-digest = DigestAlgorithm(cookie-value + secret); |

Directive data 208 may be configured to store directives such as the URL encryption and decryption directives. This follow describes various configuration directives stored in directive data 208 that are used to control and configure WAF 130 in various embodiments described herein. Each of these directives is provided in the context of the main module operation unless otherwise indicated as being within a subcontext.

General Settings

Log Directive

WAF 130 may be configured by the “log directive” for the amount and depth of log detail and file location where logs such as audit logs are saved. The log directive is illustrated in the following example:

| | |
|---|---|
| Syntax: | Log level file-path\|syslog [:facility] |
| Default: | Log 2 website_secure/secure_log |

The log directive controls how much logging information is saved and where it is saved.

Values for level may include:

| | |
|---|---|
| 0 | none |
| 1 | Informative information |
| 2 | Significant events |
| 3 | Detailed information |
| 4 | Full audit logs |

For example, the log directive may configure WAF 130 to save a log file in log data 210.
Comments Directive

WAF 130 may be configured by a “comments directive” to remove comments from webpages such as a webpage from website 108. An example of the comments directive is as follows:

| | |
|---|---|
| Syntax: | Comments On\|Off |
| Default: | Comments On |

The comments directive may be configured to turn WAF's 130 ability to remove comments from webpages “on” or “off”, for example via enabling or disabling data analyzer engine 202.
Default Action Directive

WAF 130 may be configured by a default action directive that provides default actions when a security check has failed. The following is an example of the default action directive:

| | |
|---|---|
| Syntax: | DefaultAction Deny\|Pass Log\|NoLog <response code> |
| Default: | DefaultAction Deny Log 403 |

Whenever a security test is failed by an HTTP request, WAF 130 may be configured to perform one or more actions based on the parameters selected. For example, possible values for the first parameter are:

| | |
|---|---|
| Deny | Do not pass the request onto the web server 102. As described |
| | below, when a request is denied an error page it sent to the |
| | client 150. |
| Pass | Allow the request to pass onto the web server 102. This |
| | parameter may be used to allow a user to for example, |
| | debug the WAF 130. |

Possible values for the second parameter are:

| | |
|---|---|
| Log | Log the request. When a request is logged, refer to the Log |
| | directive. |
| NoLog | Do not log the request |

The third parameter is a default HTTP response code used when the request is denied and sent back to the client 150.
Activate Directive

WAF 130 may be configured by an “activate directive” to enable and disable WAF 130. The following is an example of the activate directive:

| | |
|---|---|
| Syntax: | Activated On\|Off |
| Default: | Activated On |

In one embodiment, the activate directive may be configured to enable or disable all or portions of WAF 130. When the activate directive disables WAF 130, data requests may be passed through to the web server 102 without processing by WAF 130.
Error Page Directive

WAF 130 may be configured by an “error page directive” that configures WAF 130 to specify the location of an error page (e.g., a webpage). The following is an example of a error page directive:

| | |
|---|---|
| Syntax: | ErrorPage file-path |
| Default: | ErrorPage website_secure/error.html |

The error page directive specifies which webpage is returned when an incoming data request is blocked by WAF 130.
Frame Busting Directive

WAF 130 may be configured by a “frame busting directive” to turn frame-busting code “on” or “off”. The following is an example of a frame busting directive:

| | |
|---|---|
| Syntax: | FrameBusting On\|Off |
| Default: | FrameBusting On |

The frame busting directive configures WAF 130 to add or not add frame-busting code to each outgoing webpage. Frame-busting code is a snippet of JavaScript added to each webpage, which prevents pages from being encapsulated by HTML frames.
Request Method Directive

WAF 130 may be configured by a “request method directive” to allow or deny certain request methods. The following is an example of a request method directive:

| | |
|---|---|
| Syntax: | RequestMethod Allow\|Deny request-method [request-method] ... |
| Default: | RequestMethod Allow GET POST |

In one embodiment, the request method directive configures the WAF 130 to specify which HTTP request methods to allow or deny. For example, using an “allow” mode, each listed request method will be allowed to passed through to the web server 102. Conversely, using a “deny” mode will block each listed request method.
Server Banner Directive

WAF 130 may be configured by a “server banner directive” to cloak the web server banner. The following is an example of a server banner directive:

| | |
|---|---|
| Sntax: | ServerBanner <string> |
| Default: | ServerBanner |

The server banner directive may be used to configure WAF 130 to mask or remove the web server banner found in the HTTP response header “server”. It has become common practice to hide or disguise the running version and distribution of the web server. While such a WAF 130 configuration by the server banner directive may not eliminate all attempts to use the server response header, an empty directive value will remove the server response header entirely.
SSL Certificate Directive

WAF 130 may be configured by a “SSL certificate directive” to specify to WAF 130 the location of the certificate used to read the response to decrypt the SSL communications between the client and the web server. The following is an example of a SSL certificate directive:

Syntax: SSLCert file-path

Client Exclude Directive

WAF 130 may be configured by a “client exclude directive” to exclude HTTP clients from security conditionals. The following is an example of a client exclude directive:

Syntax: <ClientExclude> ... </ClientExclude >

Client Exclude Sub

WAF 130 may be configured by a “client exclude sub directive” to exclude HTTP certain clients from conditionals. The URLs, post data, cookies, and the like sent by these clients are not required to be protected. This is done within the context of the client exclude directive above. The following is an example of a client exclude sub directive:

Syntax: ClientExcludeSub <wildcard-hostname/ipaddress> [wildcard-
hostname/ipaddress] ...

URL Protecting Directives
On Domain Directive

WAF 130 may be configured by an “on domain directive” to configure WAF 130 to specify what hosts of URL should be protected. The on domain directive specifies what host names are to be protected. The following is an example of an on domain directive:

Syntax: OnDomain <wildcard-hostname/ipaddress> [wildcard-
hostname/ipaddress]...

When outbound URL links are analyzed by WAF 130, the on domain directive configures WAF 130 to protect certain host names as URLs to off-domain locations need not be protected. In one embodiment, the on domain directive may be used to specify what host names should be encrypted, for example, by data encryption engine 204.

URL Protect Directive

WAF 130 may be configured by a “URL protective directive” which configures WAF 130 to turn on or off URL protection. The following is an example of an URL protect directive:

Syntax: URLProtect On|Off
Default: URLProtect On

URL Exclude Directive

WAF 130 may be configured by a “URL exclude directive” that configures WAF 130 to process URL protection exclusion conditionals. The following is an example of an URL exclude directive:

Syntax: <URLExclude> ... </ URLExclude >

URL Exclude Sub Directive

In one embodiment, WAF 130 may be configured by a “URL exclude sub directive” that configures WAF 130 to exclude URL(s) from exclusion conditionals. This is done within the context of the URL exclude directive described above. The following is an example of a URL exclude sub directive:

Syntax: URLExcludeSub REGEX|PATH <regular-expression>|<url-path>

| | |
|---|---|
| Default: | URLExcludeSub PATH / |
| | URLExcludeSub PATH /robots.txt |

URLExcludeSub PATH/favicon.ico
   In one embodiment, the URL exclude sub directive may be used to exclude certain URLs from encryption analysis as in some circumstances, every URL cannot be known and encrypted ahead of time. For example, existing unencrypted URLs in search engines or other websites need to be supported as these URLs are considered safe and should be allowed through without requiring them to be encrypted. In one embodiment, a user may specify what URLs should be skipped from analysis. The URL exclude sub directive may be configured to support various ways for describing what URLs should be excluded from analysis, such as by explicit URL string (case-sensitive) description and by regular-expression description.
   Cookie Protecting Directives
   Cookies Protect Directive

In one embodiment, WAF 130 may be configured by a “cookies protective directive” to turn WAF 130 cookie protection “on” or “off”. The following is an example of a cookies protective directive:

Syntax: Cookies On|Off
Default: Cookies On

Cookies Exclude Directive

WAF 130 may be configured by a “cookies exclude directive” which may be used to configure WAF 130 to process cookie encryption exclusion conditionals. The following is an example of a cookies exclude directive:

Syntax: <CookiesExclude> ... </ CookiesExclude>

HTTP Only Exclude Directive

WAF 130 may be configured by a “HTTP only excluded directive” that process cookie HTTP only exclusion conditionals. The following is an example of a HTTP only excluded directive:

Syntax: <HTTPOnlyExclude> ... </ HTTPOnlyExclude>

Cookie Exclude Sub Directive

WAF 130 may be configured by a cookie exclude sub directive to configure WAF 130 to exclude cookie(s) from encryption protection conditionals. This is done in the context of the cookies exclude directive described above. The following is an example of a cookie exclude sub directive:

| | |
|---|---|
| Syntax: | CookieExcludeSub REGEX\|NAME |
| | <regular-expression>\|<cookie-name> |

The cookie exclude sub directive may be used to configure WAF 130 to exclude certain cookie names from encryption protection. In some circumstances, websites use JavaScript code to read/write to cookies. Encryption protecting these cookies may cause functionality on the webpage to break. In these cases, it may be advisable to specify what cookies should be skipped from protection and analysis. The cookie exclude sub directive may be configured to support various ways for describing what cookie names should be excluded from protection such as by explicit cookie name (case-sensitive) description and by regular-expression description.
HTTP Only Exclude Sub Directive

In one embodiment, WAF 130 may be configured by a HTTP only exclude sub directive to configure WAF 130 to exclude cookie(s) from HTTP only protection conditionals. This is done in the context of the HTTP only exclude directive described above. The following is an example of a HTTP only exclude sub directive:

| | |
|---|---|
| Syntax: | HTTPOnlyExcludeSub REGEX\| |
| | NAME <regular-expression>\|<cookie- |
| | name> |

The HTTP only exclude sub directive may be used to exclude certain cookie names from HTTP only protection. For example, in some circumstances, websites use JavaScript code may need to read certain cookie values. Appending HTTP only security to these cookies may cause functionality on the website to break. In these cases, it may be advisable to specify what cookies should be skipped from protection. The HTTP only exclude sub directive may be configured to support various techniques of describing what cookie names should be excluded from protection such as by explicit cookie name (case-sensitive) description and by regular-expression description.
Post Data Protecting
Post Directive

WAF 130 may be configured by a “post directive” to enable or disable Post data protection. The following is an example of a post directive:

| | |
|---|---|
| Syntax: | Post On\|Off |
| Default: | Post On |

Unicode Encoding Validation Directive

WAF 130 may be configured by a “Unicode encoding validation directive” to ensure the Unicode encoding format of the incoming post data is valid. The following is an example of a Unicode encoding validation directive:

| | |
|---|---|
| Syntax: | CheckUnicodeEncoding On\|off |
| Default: | CheckUnicodeEncoding On |

The Unicode encoding validation directive ensures that the Post Data, encoded with Unicode, has proper format. Examples include assuming UTF-8 encoding was used and checking for too few bytes (UTF-8 supports two, three, four, five, and six byte encodings), invalid encoding, and overly long characters.
URL Encoding Validation Directive

WAF 130 may be configured by a “URL encoding validation directive” to configure WAF 130 to validate URL encoding format of the incoming Post Data. The following is an example of a URL encoding validation directive:

| | |
|---|---|
| Syntax: | CheckURLEncoding On\|Off |
| Default: | CheckURLEncoding On |

The URL encoding validation directive ensures that Post Data, encoding with URL encoded, has proper format. In one embodiment, special characters may need to be encoded before they can be transmitted in the URL. Any character can be replaced using the three character combination % XY, where XY represents a hexadecimal character code (see RFC 1738 for an example). Hexadecimal numbers only allow digits and letters A to F, but attackers sometimes use other letters in order to trick the decoding algorithm. All supplied encodings are preferably checked in order to verify they are valid. The URL encoding validation directive need not check encoding in a Post payload when the multipart/form-data encoding (file upload) is used. It is not necessary to do so because URL encoding is not used for this encoding. In cases where HTML forms posted using GET are blocked can be addressed by having HTML forms submitted using Post, or using URL Exclude rules on HTML form action URLs.
Post Byte Range Directive

WAF 130 may be configured by a “post byte range directive” to only allow bytes from incoming request within a specified range. The following is an example of a post byte range directive:

| | |
|---|---|
| Syntax: | PostByteRange Byte Byte |
| Default: | PostByteRange 32 126 |

This can be useful to avoid stack overflow attacks (since they usually contain “random” binary content). For example, to only allow bytes from 32 to 126 (inclusive), the default may be used. In one embodiment, the post byte range directive need not check byte range in a post data payload when multipart/form-data encoding (file upload) is used. Doing so may prevent binary files from being uploaded. However, after the parameters are extracted from such request they may be checked for a valid range.
Post Content Type Directive

WAF 130 may be configured by a “post content type directive” to Turn WAF 130 post data protection on or off. The following is an example of a post content type directive:

| | |
|---|---|
| Syntax: | PostContentType content-type [content-type] ... |
| Default: | PostContentType application/x-www-form-urlencoded |
| | multipart/formdata |

The post content type directive may specify what content-types should be allowed when there is post data. For example, content-types other than “application/x-www-form-urlencoded” and “multipart/formdata” may not be supported by WAF 130 in some embodiments since they are not used by a typical website.
Performance Directives
URL File Cache Directive

WAF 130 may be configured by a “URL file cache directive” to specify the file location and file size where encrypted URLs will be cached such as in memory 120. The following is an example of a URL file cache directive:

| | |
|---|---|
| Syntax: | URLFileCache file-path megabytes |
| Default: | URLFileCache website_secure/secure_cache 10 |

URL Memory Cache Directive

WAF 130 may be configured by a “URL memory cache directive” to specify the memory size of cached URLs. The following is an example of a URL memory cache directive:

| | |
|---|---|
| Syntax: | URLMemoryCache kilobytes |
| Default: | URLMemoryCache cache/secure_cache 5120 |

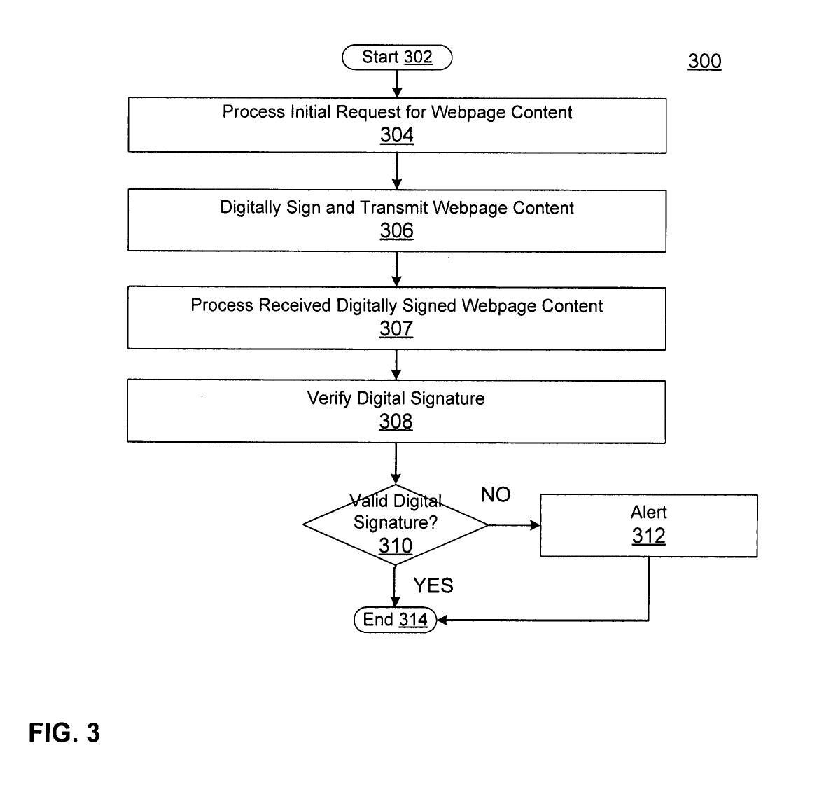

FIG. 3 is flow diagram illustrating a method 300 of securing websites. In one embodiment, WAF 130 encodes outbound HTTP response data such that when a client or interloper follows one of the links or other constructs in the response data, WAF 130 can determine the validity of the next client request. Method 300 may be initiated at step 302 when WAF 130 is activated to process requests to transmit data from web server 102 to network 140. At step 304, requests for website data are processed (e.g., a client requests webpage content from website 108). At step 306, data output associated with the requests, is digitally signed, for example, by encrypting the data being transmitted to network 140. At step 307, WAF 130 receives incoming data requests from network 140 associated with the digitally signed data output. At step 308, the incoming data requests are checked for validity by comparing the digital signature of the output data with the digital signature of the requested data associated with the digitally signed output data. If at step 310, the digital signatures of the output data and the input data are not the same, WAF 130 provides an alert at step 312. If at step 310, the digital signatures of the output and input data are the same, then at step 312, the validation process ends at step 314, and the data request is processed by the web server 102.

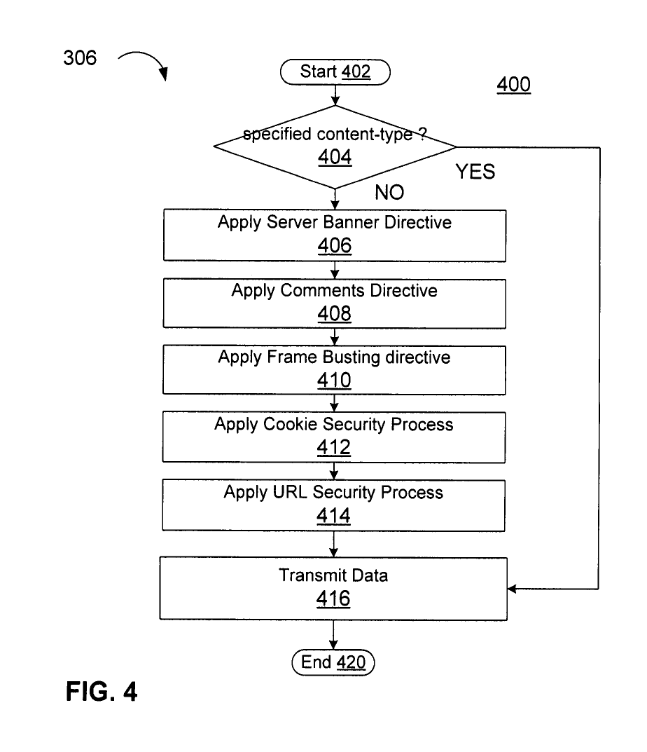

FIG. 4 is flow diagram illustrating one embodiment of a method 400 for step 306 of digitally signing data transmitted from a web server to one of more clients requesting the data. In one embodiment, method 400 may be initiated at step 402 when WAF 130 is activated to process outgoing data from web server 102. At step 404, the type of data is checked to see if it matches a specified type of data. If the data is the specified type then method 400 proceeds to transmit the data to the client 150 at step 416 and ends at step 420. For example, if a HTTP response has a specified content-type of “text/html” or “text/plain” (or has other indicia of being an analyzable document), the document will be analyzed. Otherwise, the data is passed on to client 150 without processing by the WAF 130.

At step 406, WAF 130 is configured by a server banner directive as described above. For example, the server banner directive may be used to configure WAF 130 to mask or remove the web server banner found in the HTTP response header “server”. At step 408, WAF 130 applies a comments directive as described above. For example, WAF 130 may be configured to remove comments from webpages such as a webpage from website 108. In one embodiment a frame busting directive configures WAF 130 to add or not add frame-busting code to each outgoing webpage at step 410.

In one embodiment, WAF 130 is configured to apply a cookie security process as described herein at step 412. For example, a cookie encryption directive may be used to configure WAF 130 to digitally sign cookies to be sent and/or apply one or more directives. For example WAF 130 may be configured to:
1. Apply the cookie exclude directive to determine which, if any, cookies should bypass any further security tests.
2. Apply the cookies encryption directive, described above, to digitally sign the cookies.
3. Apply the HTTP only exclude directive to determine if any cookies should be skipped from HTTP only protection.
4. Add an HTTP only flag to each cookie that was not excluded from protection.

At step 414, WAF 130 is configured to apply a URL security process as described herein. For example, a URL encryption directive may be used to configure WAF 130 to digitally sign URLs to be sent and/or apply one or more directives. For example WAF 130 may be configured to:
1. Extract one or more URLs found in the outbound webpage document, for example, by using the parsing function of WAF 130.
2. Apply the URL exclude directive to determine which, if any, URLs should bypass any further security tests.
3. Perform the URL cache lookup process as described herein to determine if any of the unencrypted URLs already exist. If any of the unencrypted URLs already exist, the cached encrypted URL is substituted for the original URL and the remaining steps may be skipped for those URLs.
4. Perform on-domain validation as described herein to determine if any URLs should bypass the encryption protection process.
5. Apply the URL encryption directive described above to each unencrypted URL.
   At step 416, WAF 130 transmits the data to the client 150 ending method 400 at step 420.

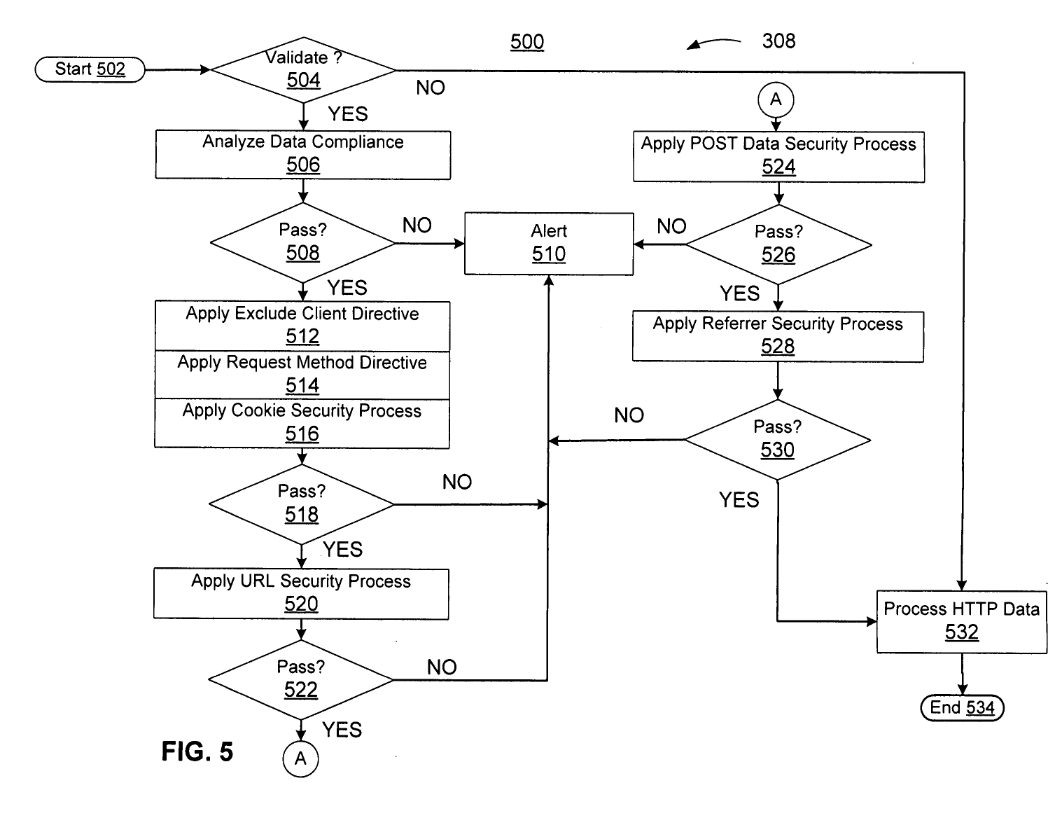

FIG. 5 is flow diagram illustrating one embodiment of a method 500 for step 308 of validating data received from one or more clients 150. In one embodiment, method 500 may be initiated at step 502 when WAF 130 is activated to process incoming data from client 150. At step 504, If the activate directive configures WAF 130 to “off”, WAF 130 passes the request through to the web server 102 at step 532, and ends at step 534. Otherwise, at step 504, if the directive is “on”, WAF 130 proceeds to validate the data from the client for compliance (e.g., format compliance) at step 506. If the data is determined not compliant at step 508, and alert is generated at step 510. For example, if client 150 provided an abnormal HTTP request, WAF 130 may respond to the client 150 with an error according to the default action directive described above. Otherwise, at step 508, if the data is deemed compliant, method 500 proceeds to step 512.

At step 512, WAF 130 is configured by the exclude client directive described above to exclude HTTP clients from security conditionals. At step 514, WAF 130 is configured by the request method directive described above to specify which HTTP request methods to allow or deny. For example, using an “allow” mode, each listed request method will be allowed to pass through to the web server 102. Conversely, using a “deny” mode will block each request method that is stored for example, in memory 120.

In one embodiment, WAF 130 is configured to apply a cookie security process as described herein at step 516. For example, a cookie encryption directive may be used to configure WAF 130 to validate digitally signed cookies that are received and/or apply one or more directives. For example, WAF 130 may be configured to:
1. Analyze the format of the incoming cookie headers for proper RFC compliance. If the format of the cookie headers is not proper, the request fails. If this step fails, the WAF 130 responds to client 150 with an error according to the steps described by the DefaultAction directive.
2. Apply the cookie exclude directive to determine which, if any, cookies should bypass any further security tests.
3. Perform data validation by decrypting and validating encrypted cookie values.
   If at step 518 a failure is detected, WAF 130 responds to client 150 with an error at step 510 for example, according to the steps described by the default action directive described above. Otherwise, if a failure is not detected, method 500 proceeds to step 520.

At step 520, WAF 130 is configured to apply a URL security process. For example, a “URL encryption directive” may be used to configure WAF 130 to validate digitally signed URLs that are received and/or apply one or more directives. For example, WAF 130 may be configured to:
1. Analyze the format of the incoming URL for proper RFC compliance. If the format of the URL is not proper, the request fails. In one embodiment, if this step fails, the WAF 130 responds to the client 150 with an error according to the steps described by the default action directive described herein.
2. Apply the URL exclude directive to determine which, if any, URLs should bypass any further security tests.
3. Perform a URL cache lookup process to determine if the incoming encrypted URL exists. If the URL does exist in cache (e.g., memory 120), the cached URL is substituted for the original URL and the remaining steps for the URL may be skipped.
4. Perform data validation by decrypting and validating the incoming encrypted URL.
   In one embodiment, if a failure is detected from step 520 at step 522, WAF 130 responds to the client 150 with an error proceeding to step 510, for example, providing an alert according to the steps described by the default action directive. Otherwise, if a failure is not detected, method 500 proceeds to step 524.

At step 524, WAF 130 is configured to apply a POST data security process. For example, a Post data directive may be used to configure WAF 130 to validate formatting of Post data received and apply one or more directives. For example, WAF 130 may be configured to:
1. Execute steps in accordance with a Post content type directive to ensure that the specified Post data is allowed.
2. Apply the Unicode encoding validation directive to the post data to ensure that the Post data, encoded with Unicode, has a proper format.
3. Apply the URL encoding validation directive to the post data to ensure that Post data, encoding with URL encoded, has proper format.
4. Apply the Postbyte range directive to allow only the bytes within the byte range from the incoming request.
   In one embodiment, if at step 526 a failure is detected from step 524, WAF 130 responds to the client 150 with an error at step 510, for example, providing an alert according to the steps described by the default action directive. Otherwise, if a failure is not detected, method 500 proceeds to step 528.

At step 528, a “referrer data directive” may be used to configure WAF 130 to validate referrers of the data received and/or apply one or more directives. For example, the referrer data directive may configure WAF 130 to apply a referrer security process. The referrer security process ensures HTTP requests proceed one webpage to the next in proper sequence. In another embodiment, the referrer security process ensures that an HTTP request does not originate from a webpage where it was not intended to be generated from. For example, the referrer security process directive may configure WAP 130 to look for the referrer of the webpage, and reject those referrers it does not recognize. In other embodiments, the referrer data directive may be used to configure WAF 130 to apply synchronous encryption directive to prevent referrer leakage.

In one embodiment, if at step 530 a failure is detected from step 528, WAF 130 responds to the client 150 with an error at step 510, for example, providing an alert according to the steps described by the default action directive. If all of the above steps pass, then the data is passed to web server 102 at step 532 and method 500 ends at step 534.

The present invention can be implemented in the form of control logic in software (e.g., a computer program) or hardware or a combination of both. The control logic may be stored in an information storage medium as a plurality of instructions adapted to direct an information-processing device to perform a set of steps disclosed in embodiments of the present invention. Based on the disclosure and teachings provided herein, a person of ordinary skill in the art will appreciate other ways and/or methods to implement the present invention.

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method of securing a server, the method comprising:
receiving a request for data associated with a website stored on a server;
digitally signing the data transmitted from the server;
receiving the digitally signed data as part of a second request; and
validating the digitally signature of the data transmitted matches the digital signature of the data received.

2. The method of claim 1, wherein digitally signing comprises encrypting the data.

3. The method of claim 2, wherein encrypting the data comprises encrypting universal resource locator links or cookies.

4. The method of claim 1, wherein digitally signing the data comprises parsing a webpage to extract the data.

5. The method of claim 4, wherein the data comprises universal resource locator links or cookies.

6. The method of claim 1, wherein receiving the digitally signed data as part of the second request comprises validating the format of the digitally signed data associated with the second request.

7. The method of claim 1, wherein validating comprises comparing data representing the digital signature of the data transmitted in response to the first data request to data representing the digital signature of the data received from the second data request.

8. The method of claim 1, wherein validating comprises comparing encrypted universal resource locator links transmitted in response to the first data request to encrypted universal resource locator links received from the second data request.

9. A computer readable medium, computational apparatus, or server computer comprising computer code for performing the method of claim 1.

10. An apparatus for securing a server, the apparatus comprising:
an encryption engine configured to digitally sign data transmitted from the server in response to a first data request; and
a validation engine configured to determine that the digital signature of the data transmitted matches a digital signature of data received as part of a second data request associated with the data transmitted.

11. The apparatus of claim 10, further comprising a parsing engine capable of extracting universal resource locator links, or cookies, or code, from the data transmitted in response to the first data request.

12. The apparatus of claim 10, wherein the encryption engine is configured to encrypt universal resource locator links.

13. The apparatus of claim 10, wherein the encryption engine is configured to encrypt cookies.

14. The apparatus of claim 10, further comprising a data analyzer engine configured to verify the format of data received as part of the second data request.

15. The apparatus of claim 10, wherein the validation engine is configured to decrypt encrypted universal resource locator links.

16. The apparatus of claim 10, wherein the encryption engine is configured to decrypt encrypted cookies.

17. A system for securing servers, the system comprising:
a server; and
a firewall coupled between the server and a network, wherein the firewall is configured to digitally sign data transmitted from the server to the network in response to a first data request from the network, and verify that data received from the network in response to a second data request associated with the data transmitted has the same digital signature.

18. The system of claim 17, wherein the server comprises a web server hosting the data.

19. The system of claim 17, wherein the firewall comprises a data analyzer engine capable of detecting format errors in the data received from the network in response to the second data request.

20. The system of claim 17, wherein the firewall comprises a data encryption engine capable of encrypting data transmitted in response to the first data request.

21. The system of claim 17, wherein the firewall comprises a data validation engine capable of decrypting data received from the second data request.

22. The system of claim 17, wherein the firewall is configured to digitally sign data in response to the first data request in a selective manner.

23. The system of claim 17, wherein the firewall is configured to validate data from the second data request in a selective manner.

24. The system of claim 17, further comprising one or more directives employed to enable or disable the firewall from digitally signing at least some of the data associated with the first data request.

25. The system of claim 17, further comprising one or more directives employed to enable or disable the firewall from validating at least some of the data associated with the second data request.
